(19) United States
(12) Patent Application Publication
(10) Pub. No.: US 2020/0238531 A1
(43) Pub. Date: Jul. 30, 2020

(54) ARTIFICIAL INTELLIGENCE MOVING ROBOT AND METHOD FOR CONTROLLING THE SAME

(71) Applicant: LG ELECTRONICS INC., Seoul (KR)

(72) Inventors: Jaehoon LEE, Seoul (KR); Jongjin WOO, Seoul (KR); Kyuchun CHOI, Seoul (KR)

(73) Assignee: LG ELECTRONICS INC., Yeongdeungpo-gu (KR)

(21) Appl. No.: 16/752,196

(22) Filed: Jan. 24, 2020

(30) Foreign Application Priority Data
Jan. 28, 2019 (KR) 10-2019-0010731

(51) Int. Cl. B25J 9/16

(52) U.S. Cl. CPC B25J 9/1697; A01D 34/008; B25J 9/163

(57) ABSTRACT

The present disclosure relates to an artificial intelligence (AI) moving robot and a method for controlling the AI moving robot. The robot may have a main body, a driving unit configured to move the main body, and an image capturing unit that captures an image around the main body and generates image information for a travel area of the main body. The robot may also have a controller. The controller may control traveling of the main body. The controller determines a status of the travel area based on the image information while the main body is traveling in the travel area. When a mode is set to a monitoring mode, the controller controls at least one of the driving unit and the image capturing unit to monitor a predesignated structure among structures in the travel area.

### CROSS-REFERENCE TO RELATED APPLICATIONS

This application claims the priority benefit of Korean Application No. 10-2019-0010731, filed on Jan. 28, 2019, the contents of which are hereby incorporated by reference herein their entirety.

### TECHNICAL FIELD

The present disclosure relates to a moving robot that autonomously travels in a travel area, and a method for controlling the moving robot.

### BACKGROUND ART

Generally, a moving robot is a device that automatically performs a predetermined operation while traveling by itself in a predetermined area without a user's operation. The moving robot senses obstacles located in the area and performs its operation by moving close to or away from such obstacles.

Such a moving robot may include a cleaning robot that carries out cleaning while traveling in the predetermined area, as well as a moving robot that mows a lawn on a bottom of the predetermined area. Generally, lawn mower devices include a riding-type device that moves according to a user's operation to cut a lawn or perform weeding when the user rides on the device, and a work-behind type or hand type device that is manually pushed or pulled by the user to move and cut a lawn. However, since the lawn mower devices move and cut a lawn according to direct operations by a user, the user may inconveniently operate the device directly. Accordingly, research has been conducted on a moving robot-type mower device, including elements that cuts a lawn.

Such a moving robot for lawn mowing (lawn mower) operates outdoors rather than indoors, and thus the moving robot for lawn mowing moves in a wider area compared to a moving robot traveling in an indoor area. In the case of indoors, a surface of the floor is monotonous (or flat), and factors such as terrain and objects affecting traveling of a moving robot are limited. On the other hand, as for outdoors, since it is an open space, there are many factors affecting traveling of a moving robot, and the traveling of the moving robot is greatly affected by the terrain. The moving robot traveling in such an outdoor environment may autonomously travel in a travel area and monitor a status (or condition) of the travel area. For example, the moving robot may monitor an unauthorized person entering the travel area or monitor any damage to structures in the travel area. However, it is not easy to set a monitoring path of the moving robot due to the nature of a wide outdoor environment, making it difficult to effectively monitor the outdoor environment.

Meanwhile, in Korean Patent Laid-Open Publication No. 10-2018-0098891 (Published on Sep. 5, 2018) (hereinafter referred to as “related art document”), a moving robot that senses a fan or a person's foot to avoid while traveling is disclosed. However, the moving robot disclosed in the related art document is limited to an indoor moving robot, and thus it is not suitable for a lawn mowing robot that travels in an outdoor environment. That is, factors and constraints regarding the outdoor environment are not taken into consideration. Accordingly, a method for controlling a moving robot's traveling that takes dynamic obstacles in the outdoor environment into account is not presented.

In other words, in the related art moving robot, as discussed above, a technology for properly monitoring an outdoor environment is not provided. As a result, there are limitations in ensuring reliability and security of a travel area. In addition, in the field of moving robot technology, in general, a technology for obviating such limitations has not been provided, and thus, a limitation or problem caused by dynamic obstacles has not been solved.

### DISCLOSURE

### Technical Problem

Therefore, an aspect of the present disclosure is to obviate the above-mentioned problems and other drawbacks.

More particularly, an aspect of the present disclosure is to provide a moving robot capable of monitoring a specific area at risk for a break-in, and a method for controlling the moving robot.

Another aspect of the present disclosure is to provide a moving robot capable of accurately and effectively monitoring a specific area, and a method for controlling the moving robot.

Still another aspect of the present disclosure is to provide a moving robot that can monitor an entire travel area by performing dynamic monitoring on the travel area, and a method for controlling the moving robot.

### Technical Solution

Embodiments disclosed herein provide a moving robot that may intensively monitor a specific structure that corresponds to predetermined criteria, among structures in a travel area, and a method for controlling the moving robot.

In detail, when the moving robot utilizing and employing an artificial intelligence (AI) technology is operated to monitor the travel area in a monitoring mode designed to monitor the travel area, or is controlled to travel for monitoring the travel area in the monitoring mode, the moving robot is controlled to intensively monitor a predesignated specific structure at risk for a break-in, among the structures in the travel area.

That is, in the moving robot and the method for controlling the moving robot according to the present disclosure, at least one of traveling of a main body and image capturing of an image capturing unit is controlled to monitor the predesignated specific structure, thereby monitoring the travel area.

Accordingly, in the moving robot and the method for controlling the moving robot according to the present disclosure, dynamic monitoring on the travel area is performed, and the specific structure at risk for a break-in is intensively monitored, thereby obviating the above-mentioned problems.

The technical features herein may be implemented as a control element for a moving robot, a method for controlling a moving robot, a method for monitoring an area with a moving robot, a control method of monitoring an area, a moving robot employing AI, a method for monitoring an area using AI, or the like. This specification provides embodiments of the moving robot and the method for controlling the moving robot having the above-described technical features.

In order to achieve the aspects and other advantages of the present disclosure, there is provided a moving robot including a main body, a driving unit moving the main body, an image capturing unit capturing an image around the main body to generate image information regarding a travel area of the main body, and a controller configured to control traveling of the main body by controlling the driving unit and determining a status of the travel area based on the image information. The controller, when a mode is set to a monitoring mode designed to monitor the travel area while traveling, may control at least one of the traveling of the main body and image capturing of the image capturing unit to monitor a predesignated specific structure among structures in the travel area, so as to monitor the travel area.

In order to achieve the aspects and other advantages of the present disclosure, there is also provided a method for controlling a moving robot including a main body, a driving unit moving the main body, an image capturing unit capturing an image around the main body, and a controller configured to control traveling of the main body by controlling the driving unit and determine a status of the travel area based on the image information, the method may include setting a monitoring mode for monitoring the travel area while traveling, starting traveling along a predetermined traveling route, monitoring a predesignated specific structure according to a predetermined monitoring reference while traveling along the traveling route, generating monitoring information of the travel area according to a result of the monitoring, and returning to an initial position.

### Advantageous Effects

In a moving robot and a method for controlling the moving robot according to the present disclosure, a specific structure at risk for a break-in can be intensively monitored by controlling the moving robot to intensively monitor the specific structure that corresponds to a predetermined reference, among structures in a travel area.

In addition, in the moving robot and the method for controlling the moving robot according to the present disclosure, a specific area can be monitored accurately and efficiently, and the entire travel area can be monitored by performing dynamic monitoring on the travel area.

Further, in the moving robot and the method for controlling the moving robot according to the present disclosure, a travel area, which is difficult to monitor periodically, can be easily monitored, thereby improving reliability and security of the travel area.

Thus, the moving robot and the method for controlling the moving robot according to the present disclosure can not only obviate limitations of the related art, but also improve accuracy, stability, reliability, applicability, efficiency, effectiveness, and utilization in the technical field of moving robots for lawn mowing utilizing and employing artificial intelligence (AI).

### BRIEF DESCRIPTION OF THE DRAWINGS

FIG. 1A is a configuration diagram (a) illustrating a moving robot according to one embodiment of the present disclosure.

FIG. 1B is a configuration diagram (b) illustrating a moving robot according to one embodiment of the present disclosure.

FIG. 1C is a configuration diagram (c) illustrating a moving robot according to one embodiment of the present disclosure.

FIG. 2 is a conceptual view illustrating one embodiment of a travel area of the moving robot according to the present disclosure.

FIG. 3A is a conceptual view illustrating a traveling principle of the moving robot according to the present disclosure.

FIG. 3B is a conceptual diagram illustrating a signal flow between devices to determine a position of the moving robot according to the present disclosure.

FIG. 4 is a detailed configuration diagram of the moving robot according to the present disclosure.

FIG. 5 is an exemplary view illustrating traveling and lawn mowing of the moving robot according to an embodiment of the present disclosure.

FIG. 6 is an exemplary view (1) illustrating an example of a monitoring target according to an embodiment of the present disclosure.

FIG. 7 is an exemplary view (2) illustrating an example of a monitoring target according to an embodiment of the present disclosure.

FIG. 8 is an exemplary view (3) illustrating an example of a monitoring target according to an embodiment of the present disclosure.

FIG. 9 is a flowchart illustrating a process of a monitoring mode performed by the moving robot according to an embodiment of the present disclosure.

FIG. 10 is a flowchart illustrating a sequence for a method for controlling the moving robot according to the present disclosure.

### MODES FOR CARRYING OUT THE PREFERRED EMBODIMENTS

Hereinafter, embodiments of a moving robot and a method for controlling the moving robot according the present disclosure will be described in detail with reference to the accompanying drawings, and the same reference numerals are used to designate the same/like components and redundant description thereof will be omitted.

In describing technologies disclosed in the present disclosure, if a detailed explanation for a related known function or construction is considered to unnecessarily divert the idea of the technologies in the present disclosure, such explanation has been omitted but would be understood by those skilled in the art. It should be noted that the attached drawings are provided to facilitate understanding of the technical idea disclosed in this specification, and should not be construed as limiting the technical idea by the attached drawings.

Hereinafter, an embodiment of a moving robot (hereinafter referred to as “robot”) according to the present disclosure will be described.

The robot may refer to a robot capable of autonomous traveling, a lawn-mowing moving robot, a lawn mowing robot, a lawn mowing device, or a moving robot for lawn mowing.

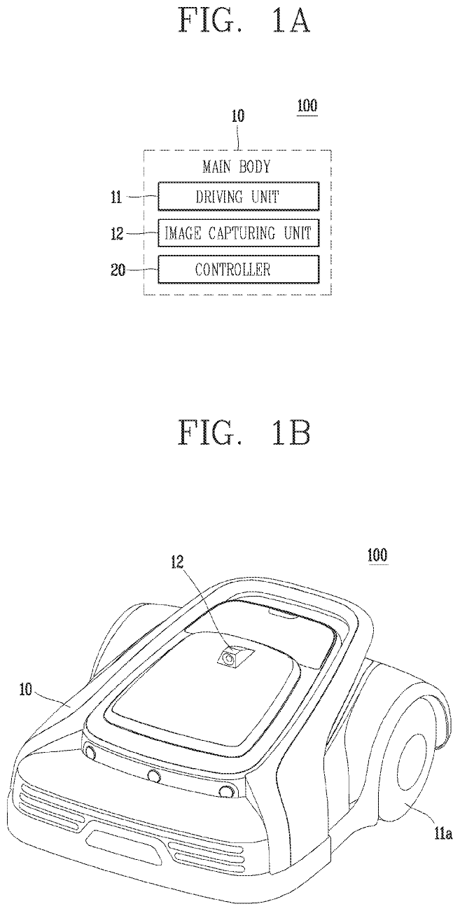

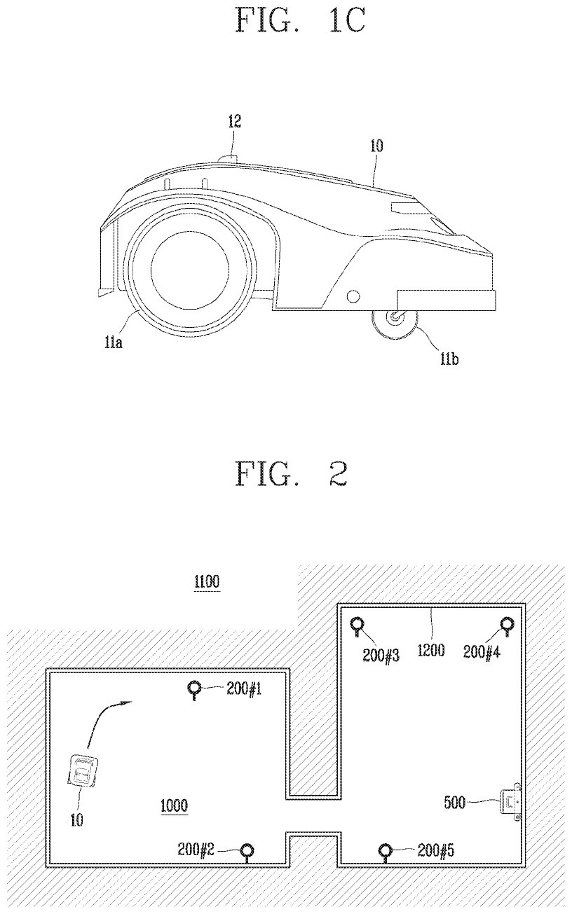

As illustrated in FIG. 1A, the robot 100 includes a main body 10, a driving unit 11 moving the main body 10, an image capturing unit 12 capturing an image of a periphery of the main body 10 to generate image information of a travel area 1000 of the main body 10, and a controller 20 controlling the driving unit 11 to control traveling of the main body 10 and determining a status (or condition of the travel area 1000 based on the image information.

The controller 20 may determine the current position of the main body 10 to control the driving unit 11 such that the main body 10 travels in the travel area 1000, and control the image capturing unit 12 to capture an image of the periphery of the main body 10 while the main body 10 is traveling in the travel area 1000, allowing the status of the travel area 1000 to be determined based on the image information generated by the image capturing unit 12.

As such, in the robot 100 including the main body 10, the driving unit 11, the image capturing unit 12, and the controller 20, when a mode is set to a monitoring mode designed to monitor the travel area 1000 while traveling, the controller 20 may control at least one of traveling of the main body 10 and image capturing of the image capturing unit 12 to monitor a predesignated specific structure (or facility) in the travel area 1000.

In other words, in the robot 100, when the monitoring mode is set, the controller 20 controls the main body 10 to travel for monitoring the specific structure.

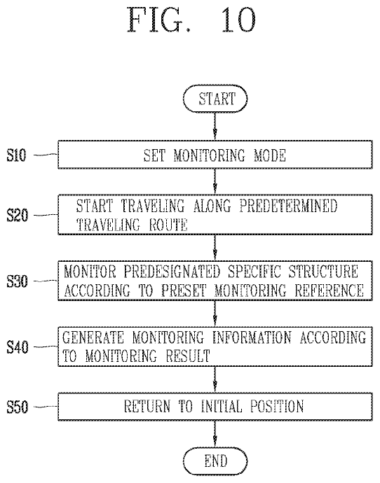

As shown in FIGS. 1B and 10, the robot 100 may be an autonomous traveling robot including the main body 10 configured to be movable so as to cut a lawn. The main body 10 forms an outer shape (or appearance) of the robot 100 and includes one or more elements performing operation such as traveling of the robot 100 and lawn mowing. The main body 10 includes the driving unit 11 that may move the main body 10 in a desired direction and rotate the main body 10. The driving unit 11 may include a plurality of rotatable driving wheels. Each of the driving wheels may individually rotate so that the main body 10 rotates in a desired direction. In detail, the driving unit 11 may include at least one main driving wheel 11a and an auxiliary wheel 11b. For example, the main body 10 may include two main driving wheels 11a, and the two main driving wheels may be installed on a rear lower surface of the main body 10.

Accordingly, the robot 100 may travel by itself within a travel area 1000 as illustrated in FIG. 2. The robot 100 may perform particular operation during traveling. Here, the particular operation may be cutting a lawn in the travel area 1000. The travel area 1000 is a target area in which the robot 100 is to travel and operate. A predetermined outside and outdoor area may be provided as the travel area 1000. For example, a garden, a yard, or the like in which the robot 100 is to cut a lawn may be provided as the travel area 1000. A charging apparatus 500 for charging the robot 100 with driving power may be installed in the travel area 1000. The robot 100 may be charged with driving power by docking with the charging apparatus 500 installed in the travel area 1000.

The travel area 1000 may be provided as a boundary area 1200 that is predetermined, as shown in FIG. 2. The boundary area 1200 corresponds to a boundary line between the travel area 1000 and an outside area 1100, and the robot 100 may travel within the boundary area 1200 not to deviate from the outside area 1100. In this case, the boundary area 1200 may be formed to have a closed curved shape or a closed-loop shape. Also, in this case, the boundary area 1200 may be defined by a wire 1200 formed to have a shape of a closed curve or a closed loop. The wire 1200 may be installed in an arbitrary area. The robot 100 may travel in the travel area 1000 having a closed curved shape formed by the installed wire 1200.

As shown in FIG. 2, a transmission device 200 may be provided in plurality in the travel area 1000. The transmission device 200 is a signal generation element configured to transmit a signal to determine position information of the robot 100. The transmission devices 200 may be installed in the travel area 1000 in a distributed manner. The robot 100 may receive signals transmitted from the transmission devices 200 to determine a current position of the robot 100 based on a result of receiving the signals or determine position information regarding the travel area 1000. In this case, a receiver of the robot 100 may receive the transmitted signals. The transmission devices 200 may be provided in a periphery of the boundary area 1200 of the travel area 1000. In this case, the robot 100 may determine the boundary area 1200 based on installed positions of the transmission devices 200 in the periphery of the boundary area 1200.

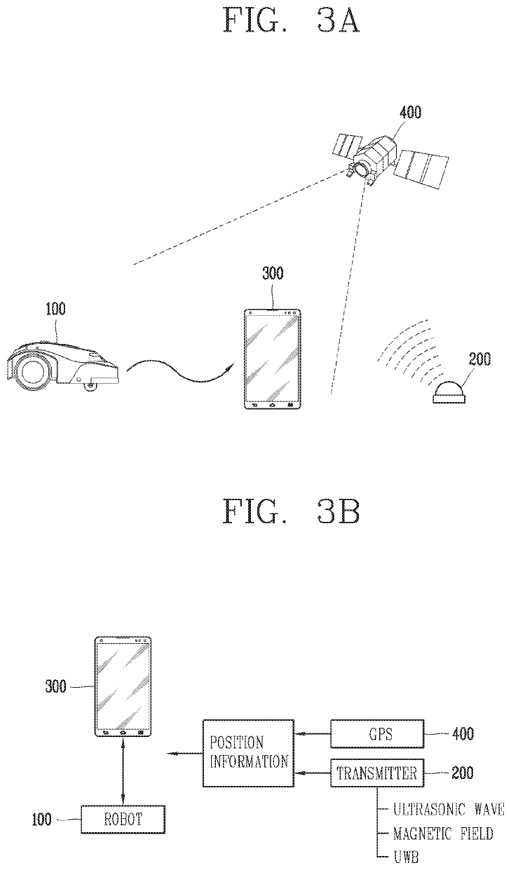

The robot 100 cutting a lawn while traveling in the travel area 1000 shown in FIG. 2 may operate according to a driving mechanism (or principle) as shown in FIG. 3A, and a signal may flow between devices for determining a position as shown in FIG. 3B.

As shown in FIG. 3A, the robot 100 may communicate with the terminal 300 moving in a predetermined area, and travel by following a position of the terminal 300 based on data received from the terminal 300. The robot 100 may set a virtual boundary in a predetermined area based on position information received from the terminal 300 or collected while the robot 100 is traveling by following the terminal 300, and set an internal area formed by the virtual boundary as the travel area 1000. When the boundary area 1200 and the travel area 1000 are set, the robot 100 may travel in the travel area 1000 not to deviate from the boundary area 1200. According to cases, the terminal 300 may set the boundary area 1200 and transmit the boundary area 1200 to the robot 100. When the terminal 300 changes or expands an area, the terminal 300 may transmit changed information to the robot 100 so that the robot 100 may travel in a new area. Also, the terminal 300 may display data received from the robot 100 on a screen to monitor operation of the robot 100.

The robot 100 or the terminal 300 may determine a current position by receiving position information. The robot 100 and the terminal 300 may determine a current position based on a signal for position information transmitted from the transmission device 200 in the travel area 1000 or a global positioning system (GPS) signal obtained using a GPS satellite 400. The robot 100 and the terminal 300 may preferably determine a current position by receiving signals transmitted from three transmission devices 200 and comparing the signals with each other. That is, three or more transmission devices 200 may be provided in the travel area 1000.

The robot 100 sets one certain point in the travel area 1000 as a reference position, and then calculates a position while the robot 100 is moving as a coordinate. For example, an initial starting position, that is, a position of the charging apparatus 500 may be set as a reference position. Alternatively, a position of one of the plurality of transmission devices 200 may be set as a reference position to calculate a coordinate in the travel area 1000. The robot 100 may set an initial position of the robot 100 as a reference position in each operation, and then determine a position of the robot 100 while the robot 100 is traveling. With respect to the reference position, the robot 100 may calculate a traveling distance based on rotation times and a rotational speed of a driving wheel, a rotation direction of a main body, etc. to thereby determine a current position in the travel area 1000. Even when the robot 100 determines a position of the robot 100 using the GPS satellite 400, the robot 100 may determine the position using a certain point as a reference position.

As shown in FIG. 3, the robot 100 may determine a current position based on position information transmitted from the transmission device 200 or the GPS satellite 400. The position information may be transmitted in the form of a GPS signal, an ultrasound signal, an infrared signal, an electromagnetic signal, or an ultra-wideband (UWB) signal. A signal transmitted from the transmission device 200 may preferably be a UWB signal. Accordingly, the robot 100 may receive the UWB signal transmitted from the transmission device 200, and determine a current position based on the UWB signal.

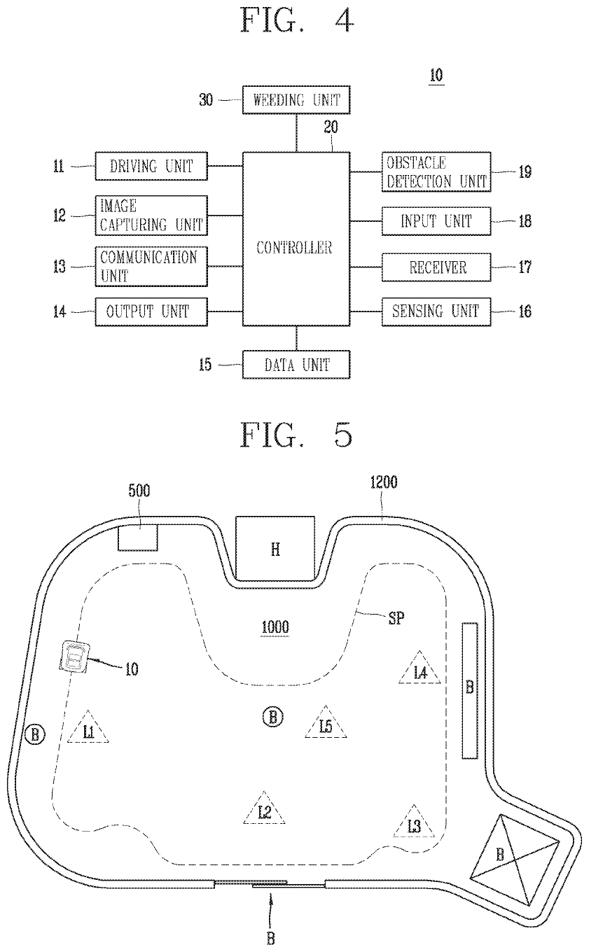

Referring to FIG. 4, the robot 100 operating as described above may include the main body 10, the driving unit 11, the image capturing unit 12, and the controller 20. When the monitoring mode is set, the robot 100 may travel in the travel area 1000 to monitor the specific structure. Also, the robot 100 may further include at least one selected from a communication unit 13, an output unit 14, a data unit 15, a sensing unit 16, a receiver 17, an input unit 18, an obstacle detection unit 19, and a weeding unit 30.

The driving unit 11 is a driving wheel included in a lower part of the main body 10, and may be rotationally driven to move the main body 10. That is, the driving unit 11 may be driven such that the main body 10 travels in the travel area 1000. The driving unit 11 may include at least one driving motor to move the main body 10 so that the robot 100 travels. For example, the driving unit 11 may include a left wheel driving motor for rotating a left wheel and a right wheel driving motor for rotating a right wheel.

The driving unit 11 may transmit information about a result of driving to the controller 20, and receive a control command for operation from the controller 20. The driving unit 11 may operate according to the control command received from the controller 20. That is, the driving unit 11 may be controlled by the controller 20.

The image capturing unit 12 may be a camera capturing a periphery of the main body 10. The image capturing unit 12 may capture an image of a forward direction of the main body 10 to detect an obstacle around the main body 10 and in the travel area 1000. The image capturing unit 12 may be a digital camera, which may include an image sensor (not shown) and an image processing unit (not shown). The image sensor is a device that converts an optical image into an electrical signal. The image sensor includes a chip in which a plurality of photodiodes is integrated. A pixel may be an example of a photodiode. Electric charges are accumulated in the respective pixels by an image, which is formed on the chip by light that has passed through a lens, and the electric charges accumulated in the pixels are converted to an electrical signal (for example, a voltage). A charge-coupled device (CCD) sensor and a complementary metal oxide semiconductor (CMOS) sensor are well known as image sensors. In addition, the image capturing unit 12 may include a Digital Signal Processor (DSP) for the image processing unit to process a captured image in order to generate the image information.

The image capturing unit 12 may transmit information about a result of image capturing to the controller 20, and receive a control command for operation from the controller 20. The image capturing unit 12 may operate according to the control command received from the controller 20. That is, the image capturing unit 12 may be controlled by the controller 20.

The communication unit 13 may communicate with at least one communication target element that is to communicate with the robot 100. The communication unit 13 may communicate with the transmission device 200 and the terminal 300 using a wireless communication method. The communication unit 13 may be connected to a predetermined network so as to communicate with the terminal 300 that controls an external server or the robot 100. When the communication unit 13 communicates with the terminal 300, the communication unit 13 may transmit a generated map to the terminal 300, receive a command from the terminal 300, and transmit data regarding an operation state of the robot 100 to the terminal 300. The communication unit 13 may include a communication module such as wireless fidelity (Wi-Fi), wireless broadband (WiBro), or the like, as well as a short-range wireless communication module such as Zigbee, Bluetooth, or the like, to transmit and receive data.

The communication unit 13 may transmit information about a result of communication to the controller 20, and receive a control command for operation from the controller 20. The communication unit 13 may operate according to the control command received from the controller 20. That is, the communication unit 13 may be controlled by the controller 20.

The output unit 14 may include an output element such as a speaker to output an operation state of the robot 100 in the form of a voice (audio). The output unit 14 may output an alarm when an event occurs while the robot 100 is operating. For example, when the power is run out, an impact or shock is applied to the robot 100, or an accident occurs in the travel area 1000, an alarm voice may be output so that the corresponding information is provided to the user.

The output unit 14 may transmit information about an operation state to the controller 20 and receive a control command for operation from the controller 20. The output unit 14 may operate according to a control command received from the controller 20. That is, the output unit 14 may be controlled by the controller 20.

The data unit 15 is a storage element that stores data readable by a microprocessor, and may include a hard disk drive (HDD), a solid state disk (SSD), a silicon disk drive (SDD), a read only memory (ROM) a random access memory (RAM), CD-ROM, a magnetic tape, a floppy disk, or an optical data storage device. In the data unit 15, a received signal may be stored, reference data to determine an obstacle may be stored, and obstacle information regarding a detected obstacle may be stored. In the data unit 15, control data that controls operation of the robot 100, data according to an operation mode of the robot 100, position information collected, and information about the travel area 1000 and the boundary area 1200 may be stored.

The sensing unit 16 may include at least one sensor that senses a posture and an operation state (or status) of the main body 10. The sensing unit 16 may include at least one selected from an inclination sensor that detects movement of the main body 10 and a speed sensor that detects a driving speed of the driving unit 11. The inclination sensor may be a sensor that senses posture information of the main body 10. When the main body 10 is inclined forward, backward, leftward, or rightward, the inclination sensor may sense the posture information of the main body 10 by calculating an inclined direction and an inclination angle. A tilt sensor, an acceleration sensor, or the like may be used as the inclination sensor. In a case of the acceleration sensor, any of a gyro type sensor, an inertial type sensor, and a silicon semiconductor type sensor may be used. In addition, various sensors or devices capable of detecting movement of the main body 10 may be used. The speed sensor may be a sensor for sensing a driving speed of a driving wheel in the driving unit 11. When the driving wheel rotates, the speed sensor may sense the driving speed by detecting rotation of the driving wheel.

The sensing unit 16 may transmit information about a result of sensing to the controller 20, and receive a control command for operation from the controller 20. The sensing unit 16 may operate according to a control command received from the controller 20. That is, the sensing unit 16 may be controlled by the controller 20.

The receiver 17 may include a plurality of signal sensor modules that transmits and receives the position information. The receiver 17 may include a position sensor module that receives the signals transmitted from the transmission device 200. The position sensor module may transmit a signal to the transmission device 200. When the transmission device 200 transmits a signal using a method selected from an ultrasound method, a UWB method, and an infrared method, the receiver 17 may include a sensor module that transmits and receives an ultrasound signal, a UWB signal, or an infrared signal, in correspondence with this. The receiver 17 may include a UWB sensor. As a reference, UWB radio technology refers to technology using a very wide frequency range of several GHz or more in baseband instead of using a radio frequency (RF) carrier. UWB wireless technology uses very narrow pulses of several nanoseconds or several picoseconds. Since pulses emitted from such a UWB sensor are several nanoseconds or several picoseconds long, the pulses have good penetrability. Thus, even when there are obstacles in a periphery of the UWB sensor, the receiver 17 may receive very short pulses emitted by other UWB sensors.

When the robot 100 travels by following the terminal 300, the terminal 300 and the robot 100 include the UWB sensor, respectively, thereby transmitting or receiving a UWB signal with each other through the UWB sensor. The terminal 300 may transmit the UWB signal to the robot 100 through the UWB sensor included in the terminal 300. The robot 100 may determine a position of the terminal 300 based on the UWB signal received through the UWB sensor, allowing the robot 100 to move by following the terminal 300. In this case, the terminal 300 operates as a transmitting side and the robot 100 operates as a receiving side. When the transmission device 200 includes the UWB sensor and transmits a signal, the robot 100 or the terminal 300 may receive the signal transmitted from the transmission device 200 through the UWB sensor included in the robot 100 or the terminal 300. At this time, a signaling method performed by the transmission device 200 may be identical to or different from signaling methods performed by the robot 100 and the terminal 300.

The receiver 17 may include a plurality of UWB sensors. When two UWB sensors are included in the receiver 17, for example, provided on left and right sides of the main body 10, respectively, the two USB sensors may receive signals, respectively, and compare a plurality of received signals with each other to thereby calculate an accurate position. For example, according to a position of the robot 100, the transmission device 200, or the terminal 300, when a distance measured by a left sensor is different from a distance measured by a right sensor, a relative position between the robot 100 and the transmission device 200 or the terminal 300, and a direction of the robot 100 may be determined based on the measured distances.

The receiver 17 may further include a GPS module for transmitting and receiving a GPS signal from the GPS satellite 400.

The receiver 17 may transmit a result of signal reception to the controller 20, and receive a control command for operation from the controller 20. The receiver 17 may operate according to the control command received from the controller 20. That is, the receiver 17 may be controlled by the controller 20.

The input unit 18 may include at least one input element such as a button, a switch, a touch pad, or the like, and an output element such as a display unit, or the like to receive a user command and output an operation state of the robot 100. For example, a command for performing the monitoring mode may be input through the display unit, and a state for performing the monitoring mode may be output through the display unit.

The input unit 18 may display a state of the robot 100 through the display unit, and display a control screen on which manipulation or an input is applied for controlling the robot 100. The control screen may mean a user interface screen on which a driving state of the robot 100 is displayed and output, and a command for driving operation of the robot 100 is input from a user. The control screen may be displayed on the display unit under the control of the controller 20, and a display and an input command on the control screen may be controlled by the controller 20.

The input unit 18 may transmit information about an operation state to the controller 20 and receive a control command for operation from the controller 20. The input unit 18 may operate according to a control command received from the controller 20. That is, the input unit 18 may be controlled by the controller 20.

The obstacle detection unit 19 includes a plurality of sensors to detect obstacles located in a traveling direction. The obstacle detection unit 19 may detect an obstacle located in a forward direction of the main body 10, that is, in a traveling direction of the main body 10 using at least one selected from a laser sensor, an ultrasonic sensor, an infrared sensor, and a three-dimensional (3D) sensor. The obstacle detection unit 19 may further include a cliff detection sensor installed on a rear surface of the main body 10 to detect a cliff.

The obstacle detection unit 19 may transmit information about a result of detection to the controller 20, and receive a control command for operation from the controller 20. The obstacle detection unit 19 may operate according to the control command received from the controller 20. That is, the obstacle detection unit 19 may be controlled by the controller 20.

The weeding unit 30 cuts grass on the bottom while traveling. The weeding unit 30 is provided with a brush or blade for cutting a lawn, so as to cut the grass on the ground in a rotating manner.

The weeding unit 30 may transmit information about a result of operation to the controller 20 and receive a control command for operation from the controller 20. The weeding unit 30 may operate according to the control command received from the controller 20. That is, the weeding unit 30 may be controlled by the controller 20.

The controller 20 may include a central processing unit to control the overall operation of the robot 100. The controller 20 may determine a status of the travel area 1000 while the robot 100 is traveling in the travel area 1000 via the main body 10, the driving unit 11, and the image capturing unit 12 to control traveling of the main body 10, and control functions and operation of the robot 100 to be performed via the communication unit 13, the output unit 14, the data unit 15, the sensing unit 16, the receiver 17, the input unit 18, the obstacle detection unit 19, and the weeding unit 30.

The controller 20 may control input and output of data, and control the driving unit 11 so that the main body 10 travels according to settings. The controller 20 may independently control operations of the left wheel driving motor and the right wheel driving motor by controlling the driving unit 11 to thereby control the main body 10 to travel rotationally or in a straight line.

The controller 20 may set the boundary area 1200 of the travel area 1000 based on position information received from the terminal 300 or position information determined based on the signal received from the transmission device 200. The controller 20 may also set the boundary area 1200 of the travel area 1000 based on position information that is collected by the controller 20 during traveling. The controller 20 may set a certain area of a region formed by the set boundary area 1200 as the travel area 1000. The controller 20 may set the boundary area 1200 in a closed loop form by connecting discontinuous position information in a line or a curve, and set an inner area within the boundary area 1200 as the travel area 1000. When the travel area 1000 and the border area 1200 corresponding thereto are set, the controller 20 may control traveling of the main body 10 so that the main body 10 travels in the travel area 1000 without deviating from the set boundary area 1200. The controller 20 may determine a current position based on received position information and control the driving unit 11 so that the determined current position is located in the travel area 1000 to thereby control traveling of the main body 10.

In addition, according to obstacle information input by at least one of the image capturing unit 12, and the obstacle detection unit 19, the controller 20 may control traveling of the main body 10 to avoid obstacles and travel. In this case, the controller 20 may modify the travel area 1000 by reflecting the obstacle information to pre-stored area information regarding the travel area 1000.

In the robot 100 having the configuration as illustrated in FIG. 4, when the monitoring mode is set, the controller 20 may control at least one of traveling of the main body 10 and image capturing of the image capturing unit 12 to monitor the travel area 1000 for monitoring the specific structure among structures in the travel area 1000.

The robot 100 may perform set operation while traveling in the travel area 1000. For example, the robot 100 may cut a lawn on the bottom of the travel area 1000 while traveling in the travel area 1000 as shown in FIG. 5.

In the robot 100, the main body 10 may travel according to driving of the driving unit 11. The main body 10 may travel as the driving unit 11 is driven to move the main body 10.

In the robot 100, the driving unit 11 may move the main body 10 according to driving of the driving wheels. The driving unit 11 may move the main body 10 by driving the driving wheels so that the main body 10 travels.

In the robot 100, the image capturing unit 12 may capture an image of the periphery of the main body 10 from a position where it is installed, and generate image information accordingly. The image capturing unit 12 may be provided at an upper portion of a rear side of the main body 10. By providing the image capturing unit 12 at the upper portion of the rear side of the main body 10, the image capturing unit 12 may be prevented from being contaminated by foreign material or dust generated by traveling of the main body 10 and lawn cutting. The image capturing unit 12 may capture an image of a traveling direction of the main body 10. That is, the image capturing unit 12 may capture an image of a forward direction of the main body 10 to travel, allowing an image of a condition ahead of the main body 10 to be captured. The image capturing unit 12 may capture an image around the main body 10 in real time to generate the image information while the main body 10 is traveling in the travel area 1000. In addition, the image capturing unit 12 may transmit a result of image capturing to the controller 20 in real time. Accordingly, the controller 20 may determine a real-time status of the travel area 1000.

In the robot 100, the controller 20 may control the driving unit 11 such that the main body 10 travels in the travel area 1000, and determine a status of the travel area 1000 based on the image information to monitor the travel area 1000. When an execution command for performing the monitoring mode, which is designed to monitor the travel area 1000 while traveling, is input through the communication unit 13 or the input unit 18, the operation mode of the robot 100 is set to the monitoring mode, so that the controller 20 controls at least one of traveling of the main body 10 and image capturing of the image capturing unit 12 according to the monitoring mode.

Hereinafter, an example in which the controller 20 controls operation of the robot 100 to monitor the travel area 1000 in the monitoring mode will be described with reference to FIG. 5.

When the monitoring mode is set, the controller 20 may control at least one of traveling of the main body 10 and image capturing of the image capturing unit 12 to monitor the specific structure B among the structures in the travel area 1000. When operation of the robot 100 is controlled according to the monitoring mode, the controller 20 may control at least one of traveling of the main body 10 and image capturing of the image capturing unit 12 to intensively monitor the specific structure B. That is, the monitoring mode may be a mode in which the predesignated specific structure B among structures in the travel area 1000 is intensively monitored while the main body 10 is traveling in the travel area 1000.

Here, the intensive monitoring may mean monitoring the specific structure B according to predetermined criteria (or references). For example, the specific structure B among the structures in the travel area 1000 is monitored by giving more value to at least one of a monitoring time, a monitoring method, a monitoring range for the specific structure B. Accordingly, the specific structure B, among the structures in the travel area 1000, may be more intensively monitored than other structures in the travel area 1000. For example, when other structures except the specific structure B are monitored for a time A, with a method B, and in a range of C, the specific structure B may be monitored for a time a+x, with a method b+y, and a range of c+z, allowing the specific structure B to be intensively monitored by giving more priority to it.

The specific structure B may be predesignated in control data of the controller 20 for controlling operation of the robot 100, a control algorithm, a control program, etc. Here, ‘predesignated’ may mean that a command or a condition for the specific structure B is set or stored in the control data, the control algorithm, the control program, and the like. The specific structure B may be predesignated by user's manipulation, a command input, or through data processing by the controller 20.

The specific structure B may mean a structure that corresponds to a predetermined reference, among the structures in the travel area 1000. The predetermined reference may be a reference for a structure that may be accessed by people or should be kept sealed, concealed, or have a risk of possible damage. The predetermined reference may be a reference for a structure at risk for a break-in. For example, it may be a reference for a structure such as a door (or gate), a window, a fence, or the like through which a stranger can gain unauthorized entry, thereby having a risk for a break-in. Accordingly, a structure at risk for the break-in may be designated as the specific structure B among the structures in the travel area 1000. In addition, the predetermined reference for designating the specific structure B may be set by user's manipulation, a command input, or through data processing by the controller 20.

Here, the controller 20 may designate the specific structure B according to the predetermined reference. The controller 20 may designate the specific structure B based on pre-stored area information of the travel area 1000. For example, a structure that corresponds to the predetermined reference among the structures in the travel area 1000 may be designated as the specific structure B based on structure information included in the area information. In addition, the controller 20 may designate a structure that corresponds to the predetermined reference among the structures in the travel area 1000 as the specific structure B according to manipulation by a user of the robot 100, a command input, and the like.

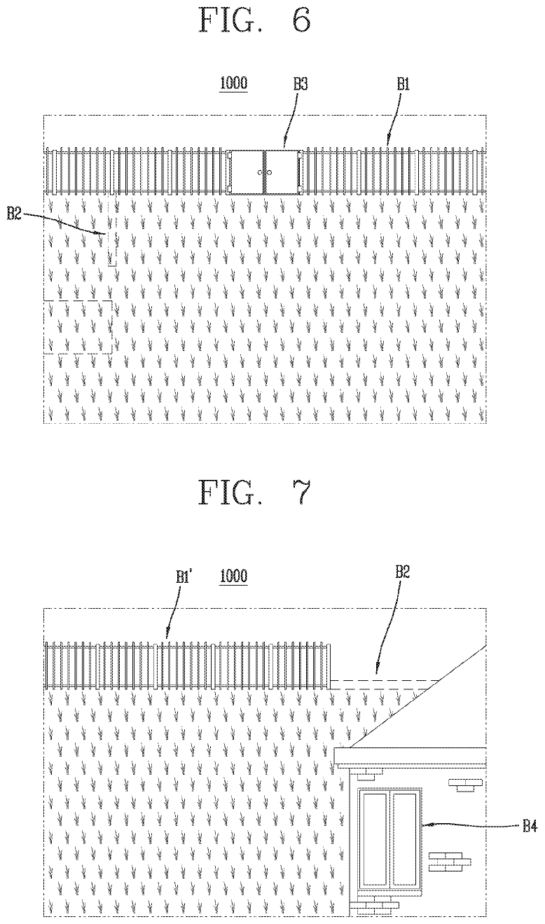

The specific structure B may be a structure including a plurality of feature lines made up of straight lines. The specific structure B may include at least one of a fence B1, a boundary line B2, a door (or gate) B3, and a window B4 in the travel area 1000, as shown in FIGS. 6 and 7. That is, at least one of the fence B1, a wall B1′, the boundary line B2, the door B3, and the window B4 in the travel area 1000 through which a stranger can gain unauthorized entry may be designated as the specific structure B.

As such, when the monitoring mode is set, at least one of traveling of the main body 10 and image capturing unit 12 may be controlled, so that the robot 100 that intensively monitors the specific structure B while monitoring the travel area 1000 may travel in the travel area 1000 as shown in FIG. 5 to intensively monitor the specific structure B.

The monitoring mode is one of the operation modes of the robot 100, which may be a mode in which the robot 100 operates to monitor the travel area 1000 by intensively monitoring the specific structure B among the structures in the travel area 1000. Accordingly, when the monitoring mode is set, the controller 20 controls at least one of traveling of the main body 10 and image capturing of the image capturing unit 12, so that the robot 100 is operated to monitor the travel area 1000 according to the monitoring mode. The monitoring mode may be a mode to monitor the travel area 1000 along a predetermined traveling route (or course) SP. That is, in the monitoring mode, the controller 20 may control the main body 10 to travel along the traveling route SP to intensively monitor the specific structure B. Accordingly, when the robot 100 operates in the monitoring mode, the robot 100 may travel along the traveling route SP to intensively monitor the specific structure B while monitoring the travel area 1000. The traveling route SP may be a route for the robot 100 to monitor the travel area 1000, which may be set by user manipulation, a command input, or the like.

In the monitoring mode, a method of traveling in the traveling route SP may differ according to a time period. That is, the monitoring mode may be executed differently according to the time period. For example, when the monitoring mode is executed in a first time period, it is performed by a first (traveling) mode, and when the monitoring mode is executed in a second time period, it is performed by a second (traveling) mode. Here, the time period and the traveling mode may be preset according to an environment in which the robot 100 is used. For example, the first time period is set from sunrise to sunset, and the second time period is set from sunset to sunrise. Visual indicators of the robot 100 may be deactivated in the first mode, and may be activated in the second mode. When the robot 100 travels in a preset reference time, the monitoring mode may be set to activate the visual indicators indicating that the robot 100 is traveling along the traveling route SP according to the monitoring mode. Here, the reference time may be a night time period. Accordingly, when the robot 100 travels in the reference time, the monitoring mode may be set to activate the visual indicators showing that the robot 100 is traveling along the traveling route SP. In the monitoring mode, when the robot 100 travels along the traveling route SP in the reference time, the controller 20 may control to restrict operations other than traveling of the main body 10 and image capturing of the image capturing unit 12. In other words, when the robot 100 travels along the traveling route SP in the reference time according to the monitoring mode, the controller 20 may control the robot 100 to travel along the traveling route SZ by restricting operations other than traveling of the main body 10 and image capturing of the image capturing unit 12. For example, in the night time period, the controller 20 may control to disable the weeding operation of the weeding unit 30, and to only enable the traveling of the main body 10 and the image capturing of the image capturing unit 12.

In the monitoring mode, the controller 20 may control the main body 10 to travel around the specific structure B and the image capturing unit 12 to capture an image according to a predetermined monitoring reference (or criteria), so as to intensively monitor the target structure B. That is, when the robot 100 is operated in the monitoring mode, the robot 100 may travel and capture an image around the specific structure B according to the monitoring reference. The monitoring reference may be a reference for intensively monitoring the specific structure B. The monitoring reference may be a reference for traveling and image capturing in a periphery of the specific structure B to intensively monitor the specific structure B. The monitoring reference may be set according to a type of the specific structure B. Accordingly, the controller 20 may intensively monitor the specific structure B according to the type of the specific structure B.

The monitoring reference may be set to travel around the specific structure B in a predetermined traveling pattern. The traveling pattern may be a pattern for the main body 10 to travel around the specific structure B for intensively monitoring the specific structure B. Accordingly, the controller 20 may control the main body 10 to travel around the specific structure B according to the traveling pattern. For example, as shown in FIG. 5, the main body 10 may be controlled to rotate around a periphery L1, L2, L3, L4, L5 of the specific structure B or repeatedly travel in the periphery L1, L2, L3, L4, L5 of the specific structure B.

The monitoring reference may be set to capture an image of the periphery of the specific structure B in a predetermined capturing pattern. The capturing pattern may be a pattern of capturing an image of the periphery of the specific structure B for intensively monitoring the specific structure B. Accordingly, the controller 20 may control the main body 10 to capture an image around the specific structure B according to the capturing pattern. For example, as illustrated in FIG. 5, the image capturing unit 12 may be controlled to capture an image in the periphery L1, L2, L3, L4, L5 of the specific structure B, or repeatedly capturing an image of the specific structure B at the periphery L1, L2, L3, L4, L5 of the specific structure B.

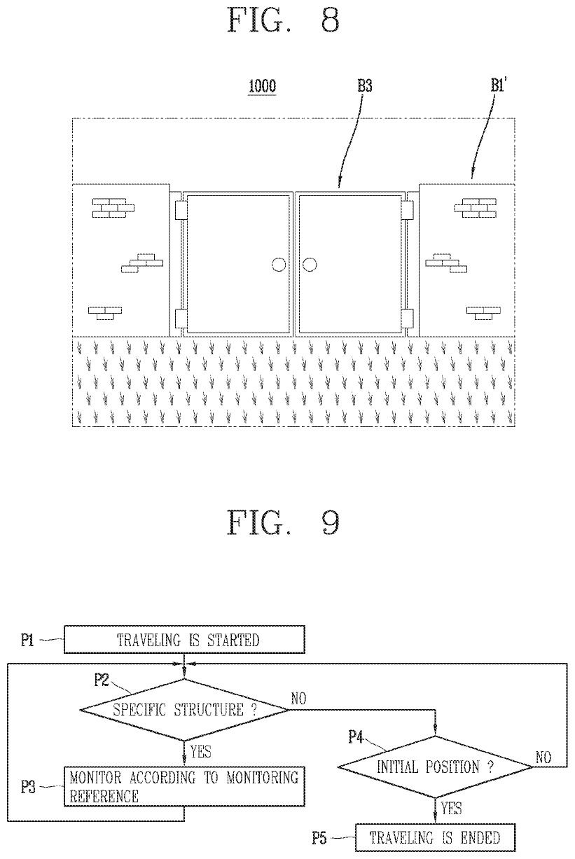

A detailed example of intensively monitoring of the specific structure B according to the monitoring reference will be described hereinafter. As illustrated in FIG. 8, the main body 10 may be controlled to travel to get close to the door B3, which is one of the specific structures B, so that the door B3 is captured (or recorded) from a position adjacent to the door B3 for a specific time, or controlled to alternately capture an image of both sides and an upper side of the door B3. As another example, the main body 10 may be controlled to travel along the fence B1, which is one of the specific structures B, to capture an image of an upper side of the fence B1.

Settings of the monitoring mode may be changed. In more detail, the controller 20 may change the settings by reflecting one of a usage pattern (or use) of the structures and information of a user (or owner) of the travel area 1000. For example, the controller 20 may change designation of the specific structure according to at least one of results of analyzing the usage pattern and analyzing the user information. For example, a structure frequently used by the user of the robot 100 may be excluded from the specific structure or be excluded from a target for monitoring according to the monitoring reference. As such, the controller 20 may learn information of an environment (or condition) for using the robot 100 based on at least one of the usage pattern and the user information, and change the monitoring mode settings according to a result of learning, or change execution of the monitoring mode. That is, the robot 100 may be controlled by the controller 20 via artificial intelligence (AI).

A detailed process of the monitoring mode for monitoring the travel area 1000 by intensively monitoring the specific structure B according to the monitoring reference will be described with reference to FIG. 9.

When the robot 100 operates according to the monitoring mode, the robot 100 may start traveling (P1) in the travel area 1000 along the predetermined traveling route SP. When the robot 100 is located near the specific structure B (P2) while traveling in the travel area 1000 along the traveling route SP for monitoring, the robot 100 intensively monitors the specific structure B according to the monitoring reference (P3). After intensively monitoring the specific structure B, the robot 100 may keep traveling until the robot 100 gets close to the next specific structure B. When the specific structure B is not around, the robot 100 may keep traveling until the next specific structure is located nearby. While traveling along the travel path SP, the robot 100 may repeat this process until the robot 100 arrives at an initial (or starting) position (P4). Then monitoring of the travel area 1000 along the traveling route SP is complete, and traveling of the robot 100 along the traveling route SP is finished (P5).

As such, when the monitoring mode is set, the controller 20 that controls at least one of traveling of the main body 10 and image capturing of the image capturing unit 12 to monitor the specific structure B for monitoring the travel area 1000 may control another configuration included in the robot 100 to perform operation according to a result of monitoring the travel area 1000.

The robot 100 may further include the communication unit 13 that is to communicate with an external communication target element, and the controller 20 may generate monitoring information regarding a result of monitoring the travel area 1000. The monitoring information may be transmitted to the communication target element from the communication unit 13. Here, the communication target element may be the terminal 300 of the user, and the like. That is, when the travel area 1000 is monitored according to the monitoring mode, the controller 20 may provide information of the monitoring result via the communication unit 13. In addition, when an object changing its position is recognized in the vicinity of the specific object B, the controller 20 may generate notification information of a result of recognizing the object. The notification information may be transmitted to the communication target element from the communication unit 13. For example, when a stranger (or unauthorized person) entered through the specific structure B, the controller 20 may recognize changes in position of the stranger around the specific structure B, and send information of the recognized changes in position of the stranger to the user of the robot 100 via the communication unit 13.

The robot 100 may further include the output unit 14 configured to output a voice. When an object changing its position around the specific object B is recognized, the controller 20 may generate an alarm signal regarding a result of recognizing the object changing its position, and output a voice via the output unit 14 according to the alarm signal. For example, an alarm sound may be output to notify a break-in. That is, when the controller 20 recognizes an object changing its position in the periphery of the specific structure B, which is an area at risk for a break-in, an alarm sound notifying the break-in may be output from the output unit 14.

The robot 100 may further include the data unit 15 in which history (or record) information of monitoring the travel area 1000 is stored. The controller 20 may generate monitoring information regarding a result of monitoring the travel area 1000 to store it in the data unit 15. The controller 20 may update the history information by storing the monitoring information into the pre-stored history information in the data unit 15. In other words, the controller 20 may accumulate data of monitoring the travel area 1000 by storing the monitoring information into the history information. As such, the controller 20 that generates the monitoring information and stores the monitoring information in the data unit 15 may compare the monitoring information with the history information to detect a change in a status (or condition) of the travel area 1000. Here, the controller 20 may further store a result of detecting the status change into the history information, and provide the result of detecting the status change to the user of the robot 100 via the communication unit 13.

The robot 100 as described above may be implemented in a method for controlling a moving robot (hereinafter referred to as “control method”) to be described hereinafter.

The control method is a method for controlling the moving robot 100 as shown in FIGS. 1A to 1C, which may be applied to the robot 100. It may also be applied to robots other than the robot 100.

The control method may be a method for controlling the robot 100 including the main body 10, the driving unit 11 moving the main body 10, the image capturing unit 12 capturing an image of a periphery of the main body 10, and the controller 20 controlling the driving unit 100 to control traveling of the main body 10 and determining a status (or condition) of the travel area 1000 based on an image captured by the image capturing unit 12, which may be a method for performing a monitoring mode in which the robot 100 monitors the travel area 1000 while traveling.

The control method may be a method in which the controller 20 controls operation of the robot 100 according to the monitoring mode to perform the monitoring mode.

The control method may be a method performed by the controller 20.

As shown in FIG. 1C, the control method may include setting a monitoring mode for monitoring the travel area 1000 while traveling (S10), staring traveling along a predetermined traveling route SP (S20), monitoring a predesignated specific structure B according to a predetermined monitoring reference while traveling along the predetermined traveling route SP (S30), generating monitoring information of the travel area 1000 according to a result of the monitoring (S40), and returning to an initial position (S50).

That is, the robot 100 may perform the monitoring mode in order from the setting (S10), the starting (S20), the monitoring (S30), the generating (S40), to returning (S50).

In the setting step S10, the monitoring mode is set to the robot 100.

In the setting step S10, when a command for executing the monitoring mode is input, an operation mode of the robot 100 may be set to the monitoring mode.

The starting step S20 may be a step in which the robot 100 starts traveling in the travel area 1000 along the traveling route SP according to the monitoring mode set at the setting step S10.

In the starting step S20, the controller 20 may control the main body 10 to travel along the traveling route SP.

The monitoring step S30 may be for intensively monitoring the specific structure B by traveling and capturing an image around the specific structure B while the robot 100 is traveling in the travel area 1000 along the traveling route SP for monitoring after starting traveling (S20).

In the monitoring step S30, the controller 20 may control traveling of the main body 10 and image capturing of the image capturing unit 12, so that the robot 100 intensively monitors the specific structure B while traveling along the traveling route SP.

In the monitoring step S30, the specific structure B may be intensively monitored according to a predetermined monitoring reference (or criteria).

In the monitoring step S30, the controller 20 may control traveling of the main body 10 and image capturing of the image capturing unit 12, so that to the robot 100 travels around the specific structure B while capturing an image, so as to intensively monitor the specific structure B according to the predetermined monitoring reference.

In the monitoring step S30, the specific structure B may be intensively monitored according to a type of the specific structure B.

In the monitoring step S30, a periphery of the specific structure B may be monitored according to a predetermined traveling pattern.

In the monitoring step S30, the specific structure B may be intensively monitored while the robot 100 is traveling around the specific structure B according to the traveling pattern.

In the monitoring step S30, an image around the specific structure B may be captured according to a predetermined capturing pattern.

In the monitoring step S30, the specific structure B may be intensively monitored by capturing an image in the periphery of the specific structure B according to the capturing pattern.

In the generating step S40, monitoring information of the travel area 1000 may be generated according to a result of the monitoring at the monitoring step S30.

In the generating step S40, the monitoring information may be stored in the data unit 15 in which history information of monitoring the travel area 1000 is stored.

In the generating step S40, the monitoring information may be transmitted to a communication target element communicating with the communication unit 13.

In the generating step S40, when an object changing its position in the periphery of the specific structure B is recognized at the monitoring step S30, notification information of the recognized object is generated to transmit the notification information to the communication target element from the communication unit 13.

In the generating step S40, when an object changing its position in the periphery of the specific structure B is recognized at the monitoring step S30, an alarm signal regarding the recognized object is generated to output a voice from the output unit 14 according to the alarm signal.

The returning step S50 may be a step for finishing the monitoring on the travel area 1000 after generating the monitoring information at the generating step S40. When the robot 100 returns to the initial position after completing the traveling route SP, monitoring of the travel area 1000 is complete.

The control method that includes the setting (S10), the starting (S20), the monitoring (S30), the generating (S40), and the returning (S50) can be implemented as computer-readable codes on a program-recorded medium. The computer-readable medium may include all types of recording devices each storing data readable by a computer system. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device and the like, and may also be implemented in the form of a carrier wave (e.g., transmission over the Internet). The computer may also include the controller 20.

The above-described embodiments of the moving robot and the method for controlling the moving robot according to the present disclosure may be applied and implemented with respect to a control element for a moving robot, a moving robot system, a control system of a moving robot, a method for controlling a moving robot, a method for monitoring an area of a moving robot, and a control method of monitoring an area of a moving robot, etc. In particular, the above-described embodiments may be usefully applied and implemented with respect to Artificial Intelligence (AI) for controlling a moving robot, a control element for a moving robot employing and utilizing AI, and a control method for a moving robot employing and utilizing AI, a moving robot employing and utilizing AI, or the like. However, the technology disclosed in this specification is not limited thereto, and may be implemented in any moving robot, a control element for a moving robot, a moving robot system, a method for controlling a moving robot, or the like to which the technical idea of the above-described technology may be applied.

While the present disclosure has been particularly shown and described with reference to embodiments thereof, it will be understood that various changes in form and details may be made therein without departing from the spirit and scope of the present disclosure as defined by the following claims. Therefore, the scope of the present disclosure should not be limited by the described embodiments, but should be determined by the scope of the appended claims and equivalents thereof.

While the present disclosure has been particularly shown and described with reference to exemplary embodiments, described herein, and drawings, it may be understood by one of ordinary skill in the art that various changes and modifications thereof may be made. Therefore, the scope of the present disclosure should be defined by the following claims, and various changes equal or equivalent to the claims pertain to the category of the concept of the present disclosure.

What is claimed is:

1. A robot comprising:
a main body;
a driving unit configured to move the main body;
an image capturing unit configured to capture an image around the main body and generate image information for a travel area of the main body; and
a controller configured to:
control traveling of the main body, and
determine a status of the travel area based on the image information while the main body is traveling in the travel area,
wherein when a mode is set to a monitoring mode, the controller controls at least one of the driving unit and the image capturing unit to monitor a predesignated structure among structures in the travel area.

2. The robot of claim 1, wherein the image capturing unit is disposed at an upper portion of a rear side of the main body.

3. The robot of claim 1, wherein the image capturing unit is configured to capture at least one image of a traveling direction of the main body.

4. The robot of claim 1, wherein the predesignated structure includes a plurality of feature lines comprising straight lines.

5. The robot of claim 4, wherein the predesignated structure includes at least one of a fence, a boundary line, a door, and a window disposed in the travel area.

6. The robot of claim 1, wherein the monitoring mode is a mode in which the robot travels along a predetermined traveling route to monitor the travel area.

7. The robot of claim 6, wherein the monitoring mode is configured so that the robot travels along the traveling route based on a selected traveling mode according to a time period.

8. The robot of claim 7, wherein the monitoring mode is set to activate visual indicators indicating that the robot is traveling along the traveling route according to the monitoring mode, when the moving robot travels during a predetermined reference time.

9. The robot of claim 8, wherein the controller is further configured to restrict operations other than the traveling of the main body and operations of the image capturing unit, when the robot travels along the traveling route during the predetermined reference time.

10. The robot of claim 1, wherein the controller controls the main body to travel around the predesignated structure and further controls the image capturing unit to capture an image around the predesignated structure according to a predetermined monitoring reference.

11. The robot of claim 10, wherein the predetermined monitoring reference is configured based on a type of the predesignated structure.

12. The robot of claim 10, wherein the predetermined monitoring reference includes traveling around the predesignated structure according to a predetermined traveling pattern.

13. The robot of claim 10, wherein the predetermined monitoring reference includes capturing an image around the predesignated structure according to a predetermined image capturing pattern.

14. The robot of claim 1, further comprising a communication unit configured to communicate with an external communication target element,
wherein the controller is further configured to transmit monitoring information to the communication target element from the communication unit.

15. The robot of claim 14, wherein when an object changing its position is recognized around the predesignated structure, the controller is further configured to transmit notification information related to the object to the communication target element from the communication unit.

16. The robot of claim 1, further comprising an output unit configured to output a voice,
wherein when an object changing its position around the predesignated structure is recognized, the controller is further configured to generate an alarm signal including the voice output from the output unit.

17. The robot of claim 1, further comprising a data unit configured to store history information of monitoring the travel area,
wherein the controller is further configured to generate monitoring information based on monitoring the travel area and to store the monitoring information in the data unit.

18. The robot of claim 17, wherein the controller is further configured to detect a change in the status of the travel area by comparing the monitoring information with the history information.

19. A method for controlling a robot including a main body, a driving unit configured to move the main body, an image capturing unit configured to capture an image around the main body, and a controller configured to control traveling of the main body and determine a status of the travel area based on the image information, the method comprising:
configuring a monitoring mode for monitoring the travel area;
traveling along a predetermined traveling route;
monitoring a predesignated structure based on a predetermined monitoring reference while traveling along the predetermined traveling route;
generating monitoring information of the travel area based on the monitoring; and
returning to an initial position.
